(19) United States
(12) Patent Application Publication
(10) Pub. No.: US 2026/0312424 A1
(43) Pub. Date: Oct. 8, 2026

(54) INTELLIGENT OPTIMIZATION ENGINE CONFIGURED FOR USE WITH AN ENERGY MANAGEMENT SYSTEM

(71) Applicant: Enphase Energy, Inc., Fremont, CA (US)

(72) Inventors: Sandeep PABBATHI, NagarKurnool, Telangana (IN); Jinendra Kacharulal GUGALIYA, Mahadevapura, Bangalore (IN)

(21) Appl. No.: 19/485,072

(22) PCT Filed: May 16, 2024
(86) PCT No.: PCT/US2024/029577

§ 371 Date: Nov. 17, 2025

(30) Foreign Application Priority Data
May 22, 2023 (IN) 202311035364

(51) Int. Cl. H02J 13/10; G06F 3/04847; G06Q 50/06; H02J 3/32; H02J 103/30

(52) U.S. Cl. CPC H02J 13/10; G06F 3/04847; G06Q 50/06; H02J 3/32; H02J 2103/30

(57) ABSTRACT

A method for managing an energy management system is provided herein. For example, the method can comprise formulating an optimization model with respect to objectives and optimization settings, modifying the optimization settings based on a user input in real-time, performing optimization using modified optimization settings; displaying the results of the optimization to the user, and if the results of the optimization are satisfactory, controlling at least one of a DER, loads, or power to battery systems using the results of the optimization, otherwise repeating modifying optimization settings based on a different user input in real-time.

### BACKGROUND

### 1. Field of the Disclosure

Embodiments of the present disclosure generally relate to power systems and, more particularly, to methods and apparatus that use an intelligent optimization engine for energy management systems.

### 2. Description of the Related Art

Home energy management systems are responsible for optimizing energy flows of a household to achieve certain objectives, such as to maximize economic savings or self-consumption of energy, sometimes referred to as a rule-based tertiary control engine (TCE).

Alternatively, an advanced approach for energy flow optimization can be based on first principles and mathematical model-based approach. Suitable mathematical models that represent one or more energy flows can be developed and used in an optimization framework to produce optimal decisions. Typically, an optimization engine can be used, which takes inputs from a forecast engine and calculates a schedule for battery charge/discharge, switch ON/OFF timings for heavy appliances such as EV or Heat Pump (HP) to save money or increase self-power consumption. The optimization engine needs information about user preference (e.g., energy bill minimization, energy independence, or weighted combination), reserve battery power limit, preferable time for charging EV etc. to generate the optimal schedules. Often, however, the settings have a trade-off and changing one of the settings can lead to changing an outcome of the optimization objective. Evolving such optimization settings in an iterative manner through various what if analysis so that a user can make an informed/educated decision would be advantageous.

Therefore, described herein are improved methods and apparatus that use an intelligent optimization engine for energy management systems.

### SUMMARY

In accordance with some aspects of the present disclosure, a method for managing an energy management system comprises formulating an optimization model with respect to objectives and optimization settings; modifying the optimization settings based on a user input in real-time; performing optimization using modified optimization settings; displaying the results of the optimization to the user; and if the results of the optimization are satisfactory, controlling at least one of a DER, loads, or power to battery systems using the results of the optimization, otherwise repeating modifying optimization settings based on a different user input in real-time.

In accordance with some aspects of the present disclosure, a non-transitory computer readable storage medium has instructions stored thereon that when executed by a processor perform a method for managing an energy management system. The method comprises formulating an optimization model with respect to objectives and optimization settings; modifying the optimization settings based on a user input in real-time; performing optimization using modified optimization settings; displaying the results of the optimization to the user; and if the results of the optimization are satisfactory, controlling at least one of a DER, loads, or power to battery systems using the results of the optimization, otherwise repeating modifying optimization settings based on a different user input in real-time.

In accordance with some aspects of the present disclosure, a controller configured for use with an energy management system comprises a tertiary control engine configured to formulate an optimization model with respect to objectives and optimization settings; modify the optimization settings based on a user input in real-time; perform optimization using modified optimization settings; display the results of the optimization to the user; and if the results of the optimization are satisfactory, control at least one of a DER, loads, or power to battery systems using the results of the optimization, otherwise repeating to modify optimization settings based on a different user input in real-time.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only a typical embodiment of this disclosure and are therefore not to be considered limiting of its scope, for the disclosure may admit to other equally effective embodiments.

FIG. 1 is a block diagram of a system for power conversion, in accordance with at least some embodiments of the present disclosure;

FIG. 2 is a block diagram of an AC battery system, in accordance with at least some embodiments of the present disclosure;

FIGS. 3A and 3B are diagrams of screenshots, in accordance with at least some embodiments of the present disclosure;

FIGS. 4A and 4B are graphs of parameters displayed in the screenshots of FIGS. 3A and 3B, respectively, in accordance with at least some embodiments of the present disclosure;

FIG. 5A is a diagram of a screenshot, in accordance with at least some embodiments of the present disclosure;

FIG. 5B is a graph of parameters displayed in the screenshot of FIG. 5A, in accordance with at least some embodiments of the present disclosure;

FIG. 6A is a diagram of a screenshot, in accordance with at least some embodiments of the present disclosure;

FIG. 6B is a graph of parameters displayed in the screenshot of FIG. 6A, in accordance with at least some embodiments of the present disclosure;

FIG. 7A is a diagram of a screenshot, in accordance with at least some embodiments of the present disclosure;

FIG. 7B is a graph of parameters displayed in the screenshot of FIG. 7A, in accordance with at least some embodiments of the present disclosure;

FIG. 8A is a diagram of a screenshot, in accordance with at least some embodiments of the present disclosure;

FIG. 8B is a graph of parameters displayed in the screenshot of FIG. 8A, in accordance with at least some embodiments of the present disclosure;

FIG. 9A is a diagram of a screenshot, in accordance with at least some embodiments of the present disclosure;

FIG. 9B is a graph of parameters displayed in the screenshot of FIG. 9A, in accordance with at least some embodiments of the present disclosure;

FIG. 10A is a diagram of a screenshot, in accordance with at least some embodiments of the present disclosure;

FIG. 10B is a graph of parameters displayed in the screenshot of FIG. 10A, in accordance with at least some embodiments of the present disclosure;

FIG. 11A is a diagram of a screenshot, in accordance with at least some embodiments of the present disclosure;

FIG. 11B is a graph of parameters displayed in the screenshot of FIG. 11A, in accordance with at least some embodiments of the present disclosure;

FIG. 12A is a diagram of a screenshot, in accordance with at least some embodiments of the present disclosure;

FIG. 12B is a graph of parameters displayed in the screenshot of FIG. 12A, in accordance with at least some embodiments of the present disclosure;

FIG. 13 is a diagram of a screenshot, in accordance with at least some embodiments of the present disclosure; and

FIG. 14 is a flowchart of a method for managing an energy management system, in accordance with at least one embodiment of the present disclosure.

### DETAILED DESCRIPTION

In accordance with the present disclosure, described herein are improved methods and apparatus that use an intelligent optimization engine for energy management systems. For example, the inventive concepts described herein provide an innovative approach to determine settings for a first-based principles optimization engine through interactive user feedback in an iterative manner. For example, a method can comprise formulating an optimization model with respect to objectives and optimization settings. Next, the method can comprise modifying the optimization settings based on a user input in real-time. Next, the method can comprise performing optimization using modified optimization settings. Next, the method can comprise displaying the results of the optimization to the user, and if the results of the optimization are satisfactory, controlling at least one of a DER, loads, or power to battery systems using the results of the optimization, otherwise repeating modifying optimization settings based on a different user input in real-time. Compared to conventional methods and apparatus described above, the methods and apparatus described herein can guide users to make informed/educated decisions considering the various trade-offs described above.

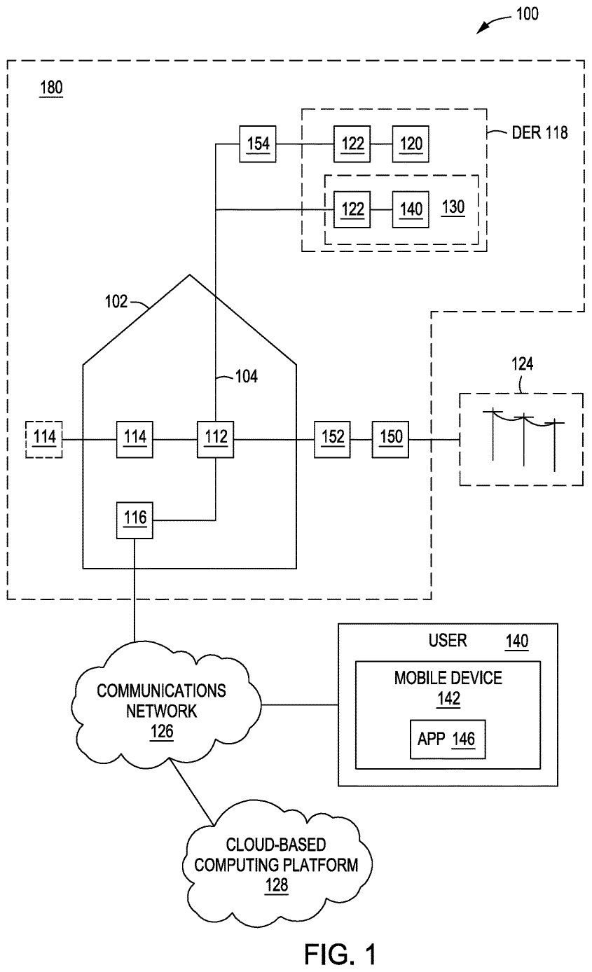

FIG. 1 is a block diagram of an energy management system (e.g., power conversion system, system 100) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure), such as a residential home, commercial building, or separate mounting structure, having an associated DER 118 (distributed energy resource). The DER 118 is situated external to the structure 102. For example, the DER 118 may be located on the roof of the structure 102 or can be part of a solar farm. The structure 102 comprises one or more loads and/or energy storage devices 114 (e.g., appliances, electric hot water heaters, thermostats/detectors, boilers, electric vehicle supply equipment (EVSE), EVs, water pumps, and the like), which can be located within or outside the structure 102, and a DER controller 116, each coupled to a load center 112. Although the energy storage devices 114, the DER controller 116, and the load center 112 are depicted as being located within the structure 102, one or more of these may be located external to the structure 102.

The load center 112 is coupled to the DER 118 by an AC bus 104 and is further coupled, via a meter 152 and optionally a MID 150 (microgrid interconnect device), to a grid 124 (e.g., a commercial/utility power grid). The structure 102, the energy storage devices 114, DER controller 116, DER 118, load center 112, generation meter 154, the meter 152, and the MID 150 are part of a microgrid 180. It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122. For example, the DER 118 may comprise a plurality of RESs 120 coupled to a plurality of power conditioners 122 in a one-to-one correspondence (or two-to-one). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one correspondence, where each pair of power conditioner 122 and a corresponding battery may be referred to as an AC battery 141.

Additionally, the inventors have found that an electric vehicle (EV) can be considered a mobile DER, which may be charged with either clean or dirty energy. For example, in at least some embodiments, methods and apparatus described herein can determine and assign an EV with a NEM score or metric that indicates a quantity of renewable energy stored in the EV. Thus, the inventive concepts described herein provide a methodology for measuring clean versus dirty energy used for charging the EV, maintaining an ongoing NEM score, and many ways of using and displaying that information, as described in greater detail below.

The power conditioners 122 invert the generated DC power from the plurality of RESs 120 and/or the AC battery 141 to AC power that is grid-compliant and couple the generated AC power to the grid 124 via the load center 112. The generated AC power may be additionally or alternatively coupled via the load center 112 to the one or more loads (e.g., EV, EVSE) and/or the energy storage devices 114. In addition, the power conditioners 122 that are coupled to the AC batteries convert AC power from the AC bus 104 to DC power for charging the AC batteries. A generation meter 154 is coupled at the output of the power conditioners 122 that are coupled to the plurality of RESs 120 in order to measure generated power.

In at least some embodiments, the power conditioners 122 may be AC-AC converters that receive AC input and convert one type of AC power to another type of AC power. Alternatively, the power conditioners 122 may be DC-DC converters that convert one type of DC power to another type of DC power. The DC-DC converters may be coupled to a main DC-AC inverter for inverting the generated DC output to an AC output. Any AC to DC device which is configured to convert AC generated from renewable sources to DC can be used for charging an EV, e.g., a bidirectional inverter such as a simple charger onboard an EV. A key aspect of the present disclosure is the ability of measuring the energy (AC or DC) supplied to an EV battery.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway that receives data (e.g., alarms, messages, operating data, performance data, and the like) from the power conditioners 122 and communicates the data and/or other information via the communications network 126 to a cloud-based computing platform 128, which can be configured to execute one or more application software, e.g., a grid connectivity control application, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein. For example, the DER controller 116 can include a memory (e.g., a non-transitory computer readable storage medium) having stored thereon instructions that when executed by a processor perform a method for auditing and tracking clean energy flow amongst DERs, e.g., an EVs, as described in greater detail below.

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (kWh) and, in some embodiments, reactive power flow (KVAR). The generation meter 154 may communicate the measured values to the DER controller 116, for example using PLC, other types of wired communications, or wireless communication. Additionally, battery charge/discharge values are received through other networking protocols from the battery 130 itself.

The meter 152 may be any suitable energy meter that measures the energy consumed by the microgrid 180, such as a net-metering meter, a bi-directional meter that measures energy imported from the grid 124 and well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kWh), reactive power flow (kVAR), grid frequency, and grid voltage. The meter 152 measures power flows independently of MID state, i.e., when MID is closed and DER's are connected to the grid and when MID is open and DER's are isolated from the grid.

The MID 150, which may also be referred to as an island interconnect device (IID), connects/disconnects the microgrid 180 to/from the grid 124. The MID 150 comprises a disconnect component (e.g., a contactor or the like) for physically connecting/disconnecting the microgrid 180 to/from the grid 124. For example, the DER controller 116 receives information regarding the present state of the system from the power conditioners 122, and also receives the energy consumption values of the microgrid 180 from the meter 152 (for example via one or more of PLC, other types of wired communication, and wireless communication), and based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124.

In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, or the like) communicably coupled by wireless means to the communications network 126. The mobile device 142 has a CPU, support circuits, and memory, and has one or more applications (e.g., a grid connectivity control application (an application 146)) installed thereon for controlling the connectivity with the grid 124 as described herein. The mobile device 142 may run on commercially available operating systems, such as IOS, ANDROID, and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, the scenarios below, listed in order of priority, will be managed differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate.

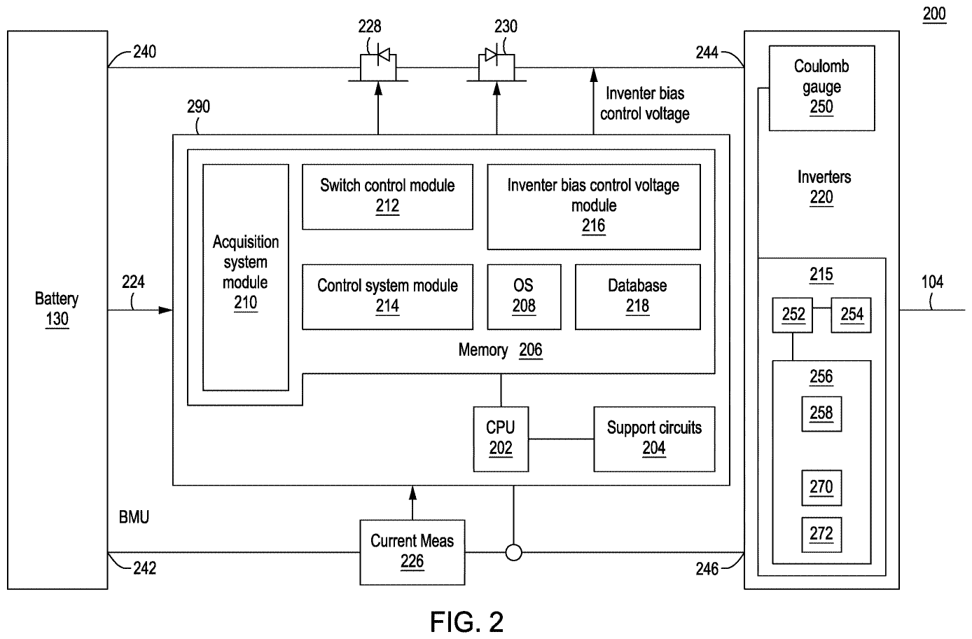

A storage system configured for use with an energy management system, such as the Enphase® Energy System, is described herein. For example, FIG. 2 is a block diagram of an AC battery system 200 (e.g., a storage system) in accordance with one or more embodiments of the present disclosure.

The AC battery system 200 comprises a BMU 290 coupled to a battery (e.g., the battery 130) and two or more power converters 202 s (e.g., the power conditioners 122). In at least some embodiments, the battery 130 can comprise a plurality of cells (not shown) and the power converters 220 can comprise four embedded converters (e.g., four embedded microinverters). In at least some embodiments, the battery 130 can be the IQ Battery 3 (or the IQ Battery 10) and the microinverters can be the IQ8X-BAT microinverters, both available from Enphase®. A pair of metal-oxide-semiconductor field-effect transistors (MOSFETs) switches-switches 228 and 230—are coupled in series between a first terminal 240 of the battery 130 and a first terminal 244 of the power converter such that the body diode cathode terminal of the switch 228 is coupled to the first terminal 240 of the battery 130 and the body diode cathode terminal of the switch 230 is coupled to the first terminal 244 of the power converter 220. The gate terminals of the switches 228 and 230 are coupled to the BMU 290.

A second terminal 242 of the battery 130 is coupled to a second terminal 246 of the power converter 220 via a current measurement module 226 which measures the current flowing between the battery 130 and the power converter 220.

The BMU 290 is coupled to the current measurement module 226 for receiving information on the measured current, and also receives an input 224 from the battery 130 indicating the battery cell voltage and temperature. The BMU 290 is coupled to the gate terminals of each of the switches 228 and 230 for driving the switch 228 to control battery discharge and driving the switch 230 to control battery charge as described herein. The BMU 290 is also coupled across the first terminal 244 and the second terminal 246 for providing an inverter bias control voltage (which may also be referred to as a bias control voltage) to the power converter 220.

The configuration of the body diodes of the switches 228 and 230 allows current to be blocked in one direction but not the other depending on state of each of the switches 228 and 230. When the switch 228 is active (i.e., on) while the switch 230 is inactive (i.e., off), battery discharge is enabled to allow current to flow from the battery 130 to the power converter 220 through the body diode of the switch 230. When the switch 228 is inactive while the switch 230 is active, battery charge is enabled to allow current flow from the power converter 220 to the battery 130 through the body diode of the switch 228. When both switches 228 and 230 are active, the system is in a normal mode where the battery 130 can be charged or discharged.

The BMU 290 comprises support circuits 204 and a memory 206 (e.g., non-transitory computer readable storage medium), each coupled to a CPU 202 (central processing unit). The CPU 202 may comprise one or more processors, microprocessors, microcontrollers and combinations thereof configured to execute non-transient software instructions to perform various tasks in accordance with embodiments of the present disclosure. The CPU 202 may additionally or alternatively include one or more application specific integrated circuits (ASICs). In some embodiments, the CPU 202 may be a microcontroller comprising internal memory for storing controller firmware that, when executed, provides the controller functionality described herein. The BMU 290 may be implemented using a general purpose computer that, when executing particular software, becomes a specific purpose computer for performing various embodiments of the present disclosure.

The support circuits 204 are well known circuits used to promote functionality of the CPU 202. Such circuits include, but are not limited to, a cache, power supplies, clock circuits, buses, input/output (I/O) circuits, and the like. The BMU 290 may be implemented using a general purpose computer that, when executing particular software, becomes a specific purpose computer for performing various embodiments of the present disclosure. In one or more embodiments, the CPU 202 may be a microcontroller comprising internal memory for storing controller firmware that, when executed, provides the controller functionality described herein.

The memory 206 may comprise random access memory, read only memory, removable disk memory, flash memory, and various combinations of these types of memory. The memory 206 is sometimes referred to as main memory and may, in part, be used as cache memory or buffer memory. The memory 206 generally stores the OS 208 (operating system), if necessary, of the inverter controller 215 that can be supported by the CPU capabilities. In some embodiments, the OS 208 may be one of a number of commercially available operating systems such as, but not limited to, LINUX, Real-Time Operating System (RTOS), and the like.

The memory 206 stores non-transient processor-executable instructions and/or data that may be executed by and/or used by the CPU 202 to perform, for example, one or more methods for discharge protection, as described in greater detail below. These processor-executable instructions may comprise firmware, software, and the like, or some combination thereof. The memory 206 stores various forms of application software, such as an acquisition system module 210, a switch control module 212, a control system module 214, and an inverter bias control module 216. The memory 206 additionally stores a database 218 for storing data related to the operation of the BMU 290 and/or the present disclosure, such as one or more thresholds, equations, formulas, curves, and/or algorithms for the control techniques described herein. In various embodiments, one or more of the acquisition system module 210, the switch control module 212, the control system module 214, the inverter bias control module 216, and the database 218, or portions thereof, are implemented in software, firmware, hardware, or a combination thereof.

The acquisition system module 210 obtains the cell voltage and temperature information from the battery 130 via the input 224, obtains the current measurements provided by the current measurement module 226, and provides the cell voltage, cell temperature, and measured current information to the control system module 214 for use as described herein.

The switch control module 212 drives the switches 228 and 230 as determined by the control system module 214. The control system module 214 provides various battery management functions, including protection functions (e.g., overcurrent (OC) protection, overtemperature (OT) protection, and hardware fault protection), metrology functions (e.g., averaging measured battery cell voltage and battery current over, for example, 100 ms to reject 50 and 60 Hz ripple), state of charge (SoC) analysis (e.g., coulomb counter 250 (or coulomb gauge) for determining current flow and utilizing the current flow in estimating the battery SoC; synchronizing estimated SoC values to battery voltages (such as setting SoC to an upper bound, such as 100%, at maximum battery voltage; setting SoC to a lower bound, such as 0%, at a minimum battery voltage); turning off SoC if the power converter 220 never drives the battery 130 to these limits; and the like), balancing (e.g., autonomously balancing the charge across all cells of a battery to be equal, which may be done at the end of charge, at the end of discharge, or in some embodiments both at the end of charge and the end of discharge). By establishing upper and lower estimated SoC bounds based on battery end of charge and end of discharge, respectively, and tracking the current flow and cell voltage (i.e., battery voltage) between these events, the BMU 290 determines the estimated SoC.

An inverter controller 215 comprises support circuits 254 and a memory 256, each coupled to a CPU 252 (central processing unit). The CPU 252 may comprise one or more processors, microprocessors, microcontrollers and combinations thereof configured to execute non-transient software instructions to perform various tasks in accordance with embodiments of the present disclosure. The CPU 252 may additionally or alternatively include one or more application specific integrated circuits (ASICs). In some embodiments, the CPU 252 may be a microcontroller comprising internal memory for storing controller firmware that, when executed, provides the controller functionality herein. The inverter controller 215 may be implemented using a general purpose computer that, when executing particular software, becomes a specific purpose computer for performing various embodiments of the present disclosure.

The support circuits 254 are well known circuits used to promote functionality of the CPU 252. Such circuits include, but are not limited to, a cache, power supplies, clock circuits, buses, input/output (I/O) circuits, and the like. The inverter controller 215 may be implemented using a general purpose computer that, when executing particular software, becomes a specific purpose computer for performing various embodiments of the present disclosure. In one or more embodiments, the CPU 252 may be a microcontroller comprising internal memory for storing controller firmware that, when executed, provides the controller functionality described herein.

The memory 256 may comprise random access memory, read only memory, removable disk memory, flash memory, and various combinations of these types of memory. The memory 256 is sometimes referred to as main memory and may, in part, be used as cache memory or buffer memory. The memory 256 generally stores the OS 258 (operating system), if necessary, of the inverter controller 215 that can be supported by the CPU capabilities. In some embodiments, the OS 258 may be one of a number of commercially available operating systems such as, but not limited to, LINUX, Real-Time Operating System (RTOS), and the like.

The memory 256 stores non-transient processor-executable instructions and/or data that may be executed by and/or used by the CPU 252. These processor-executable instructions may comprise firmware, software, and the like, or some combination thereof. The memory 256 stores various forms of application software, such as a power conversion control module 270 for controlling the bidirectional power conversion, and a battery management control module 272.

The BMU 290 communicates with the DER controller 116 to perform balancing of the batteries (e.g., multi-C-rate collection of AC batteries) based on a time remaining before each of the batteries are depleted of charge, to perform droop control (semi-passive) which allows the batteries to run out of charge at substantially the same time, and perform control of the batteries to charge batteries having less time remaining before depletion using batteries having more time remaining before depletion.

A user (e.g., the user 140) of an energy management system (e.g., the system 100), such as home energy management system (HEMS), may not understand or appreciate the complex mathematics based tertiary control engine (TCE). Accordingly, the BMU 290 communicates with the DER controller 116 to allow a user to control the system 100 using a tertiary control engine (TCE). For example, the inventive concepts described herein helps a user to select (e.g., using the mobile device 142) the correct settings that need to be provided to an optimization engine (e.g., the application 146), without being troubled by the underlying complex mathematics. For example, the inventive concepts described herein provides an iterative approach to fine tune the user's choices in accomplishing an end objective in an intuitive manner. For example, through an intuitive and interactive user interface (UI), a user can select and fine tune various settings, and the optimization engine can show the possible energy charges and grid import/export energy for a selected time horizon from a current time. The intuitive and interactive user interface described herein enables a user to choose the right system settings to save cost and/or maximize, for example, self-consumption. For example, an interactive UI based tool is configured to allow a user to input settings to the optimization engine, as described in greater detail below.

Suitable mathematics and first principles-based models are developed, and the first principles-based models are added to an optimization goal-based formulation. For example, Table 1 lists symbol notations and nomenclature as used herein.

TABLE 1

| | Variable | |
|---|---|---|
| S. No. | Notation | Description |
| 1 | Pₛₒₗₐᵣ(t) | PV Power generated in kW at time t |
| 2 | P_{load}(t) | Consumption power at home in kW |
| 3 | Pᵢₘₚ(t) | Import power from grid to home in kW |
| 4 | Pₑₓₚ(t) | Export power to the grid from home in kW |
| 5 | P_{curtl}(t) | PV curtailed power in kW |
| 6 | P_{bat-c}(t) | Battery charge power in kW |
| 7 | P_{bat-d}(t) | Battery discharge power in kW |
| 8 | SOC_{bat}(t) | State of charge of battery in kWh |
| 9 | Cᵢₘₚ(t) | Grid import rate ($/kWh) |
| 10 | Cₑₓₚ(t) | Grid export rate ($/kWh) |
| 11 | Pᵢₘₚ₋ₗᵢₘᵢₜ | Power Import Limit in kW |
| 12 | Pₑₓₚ₋ₗᵢₘᵢₜ | Power Export Limit in kW |
| 13 | P_{bat-max} | Max Battery Charge/Discharge rate in kW |
| 14 | SOC_{bat-init} | Initial Battery SOC |
| 15 | Rᵢₘₚ(t) | Binary flag to indicate grid import (0, 1) |
| 16 | Rₑₓₚ(t) | Binary flag to indicate grid export (0, 1) |
| 17 | R_{bat-c}(t) | Binary flags to indicate battery charge |
| 18 | R_{bat-d}(t) | Binary flags to indicate battery discharge |
| 19 | w₁ | Weight for optimization |
| 20 | w₂ | Weight for optimization |
| 21 | tₛₜₑₚ | Time step in minutes |
| 22 | n_{H} | Time Horizon (24 hours) |

### Optimization Goal:

### a) Savings

The savings goal involves minimizing Equation 1 (a):

$$Obj = \sum {( {P}_{imp}}_{t = 1}^{\text{?}} ( t ) * {C}_{imp} ( t ) - {P}_{exp} ( t ) * {C}_{exp} ( t ) ) * ( {t}_{step} / 60 ) \qquad 1 ( a )$$

$$\text{?} \text{indicates text missing or illegible when filed}$$

Equation 1 (a) has two terms, namely, import power charges and export power revenues. Though for simplicity, Equation 1 (a) only involves import and export charges. In at least some embodiments, one or more other terms related to demand charge rates and threshold-based power tariffs based on problem definition can be added.

### b) Self-Consumption

In self-consumption-based objective, using Equation 1 (b), the optimization engine minimizes the imported energy from the grid so that in-house generated energy is used to the maximal extent.

$$Obj = ( \sum {( {P}_{imp}}_{t = 1}^{\text{?}} ( t ) \text{?} ( {t}_{step} / 60 ) \qquad 1 ( b )$$

$$\text{?} \text{indicates text missing or illegible when filed}$$

### c) Combination of Self-Consumption and Saving

In the combination of self-consumption and saving objective, suitable weighted combinations of self-consumption Equation 1 (b) and savings Equation1 (a) goals are optimized. Thus, if the weighted combinations are tuned, a user can get the best of both objectives. The optimization engine uses the underlying physics of the optimization problem while optimizing for the objective given as per Equation 1 (a), Equation 1 (b) or Equation 1 (c).

$$Obj = {w}_{1} ( \sum \text{?} ( \text{?} / 60 ) ) \text{?} {w}_{2} \text{?} ( \text{?} / 60 ) \qquad \text{?}$$

$$\text{?} \text{indicates text missing or illegible when filed}$$

Several constraints can be added to the optimization problem. For example, in at least some embodiments, constraints for optimization can comprise grid related constraints. In such embodiments, Equations 2 (a)-2 (d) can be used.

$${R}_{imp} ( t ) + {R}_{exp} ( t ) \leq 1 R \text{?} ( 0 , 1 ) \qquad 2 ( a )$$

$$0 \leq {P}_{imp} ( t ) \leq {P}_{imp - limit} * {R}_{imp} ( t ) \qquad 2 ( b )$$

$$0 \leq {P}_{exp} ( t ) \leq {P}_{exp - limit} * {R}_{exp} ( t ) \qquad 2 ( c )$$

$${P}_{exp} ( t ) \leq {P}_{solar} ( t ) if DCG = False \qquad 2 ( d )$$

$$\text{?} \text{indicates text missing or illegible when filed}$$

In at least some embodiments, constraints for optimization can comprise battery related constraints. In such embodiments, Equations 3(a)-3(h) can be used.

$${R}_{bat \_ c} ( t ) + {R}_{bat \_ d} ( t ) \leq 1 R \text{?} ( 0 , 1 ) \qquad 3 ( a )$$

$$0 \leq {P}_{bat \_ c} ( t ) \leq {P}_{bat - max} * {R}_{bat \_ c} ( t ) \qquad 3 ( b )$$

$$0 \leq {P}_{bat \_ d} ( \text{?} ) \leq {P}_{bat - max} * {R}_{bat \_ c} ( \text{?} ) \qquad 3 ( c )$$

$${P}_{bat - c} ( t ) \leq {P}_{solar} ( t ) if CG = False \qquad 3 ( d )$$

$$3 ( e )$$

$${SOC}_{bat} ( t ) = {SOC}_{bat} ( t - 1 ) + {P}_{bat - c} ( t ) * ( {t}_{step} / 60 ) * {η}_{bat} - {P}_{bat - d} ( t ) * ( {t}_{step} / 60 ) * ( 1 / {η}_{bat} )$$

$${SOC}_{bat} ( {t}_{0} ) = SO \text{?} \qquad 3 ( f )$$

$${SOC}_{bat - res} \leq {SOC}_{bat} ( t ) \leq {SOC}_{bat - m} \qquad 3 ( g )$$

$${SOC}_{bat} ( {t}_{end} ) = SOC \text{?} \qquad 3 ( h )$$

$$\text{?} \text{indicates text missing or illegible when filed}$$

Equation 3(a) allows a battery to either import or export. Equations 3(b) and 3(c) limits battery import/export to max allowed limit. Equation 3(d) limits battery to discharge to the extent solar power is available in case charge from grid is false. Equation 3(e) models the battery energy balance equation. Equation 3(f) is related to battery SoC at a start of an optimization horizon. Equation 3(g) ensures battery SoC does not go below a reserve SoC limit. Equation 3(h) ensures zero net battery energy import/export during the optimization horizon.

In at least some embodiments, constraints for optimization can comprise power balance related constraints. In such embodiments, Equation 4(a) can be used.

$${P}_{{solar}^{( t )}} - \text{?} - {P}_{{load}^{( t )}} + {P}_{{imp}^{( t )}} - {P}_{{exp}^{( t )}} + {P}_{bat - {d}^{( t )}} - {P}_{bat - {c}^{( t )}} = 0 \qquad 4 ( a )$$

$$\text{?} \text{indicates text missing or illegible when filed}$$

Equation 4(a) is used for energy balance at a home level. Thus, the HEMS minimizes the Equation 1(c) with one or more constraints from Equations 2(a) to 4(a). In at least some embodiments, an optimization time step tₛₜₑₚ can be equal to about 15 minutes and the time horizon n_{H} can be equal to about 24 hours.

In at least some embodiments, the optimization engine described herein can be used to handle conflicting objectives of self-consumption and savings and can be used to fine tune a reserve State of Charge (SoC) limit, balancing tradeoff between savings and uncertainty of power blackouts.

For example, to illustrate the advantages of the optimization engine, the optimization engine is configured for optimization of self-consumption and is compared with rule based TCE. For example, in the rule based TCE, the self-consumption objective is implemented with a battery mode called Zero Neutral (ZN). In such a mode, a load is balanced with PV power first, then the next preference is given to battery power, and the remaining power is imported from the grid. On the other hand, any excess PV power is exported to the grid as well. In the rule based TCE, the economics in cost savings is not determined, and a primary goal of the rule based TCE is to reduce import energy from the grid. Conversely, with the optimization based self-consumption implementation, import energy form grid is reduced without compromising on the cost savings. In at least some embodiments, the optimization setting and the dynamic inputs for the optimization that can be used are listed in Table 2 and Table 3, respectively.

TABLE 2

| Settings | Value | |
|---|---|---|
| Battery capacity | 3*3 | kWh |
| Battery Charge/Discharge rate | 3*1.28 | kW |
| DCR price | NA | |
| Grid import limit | 6 | kW |
| Grid export limit | 3 | kW |

| | |
|---|---|
| Charge from grid | FALSE |
| Discharge to grid | FALSE |
| Profile_mode | self-consumption |

TABLE 3

| Dynamic inputs | Value |
|---|---|
| Optimization time step | 15 min |
| Solar/load forecast | in kW (24 hrs - one full day) |
| Grid import/export rates | in ($/kWh) (24 hrs - one full day) |
| Battery initial charge | 40% of Capacity |
| Battery backup charge | 40% of Capacity |

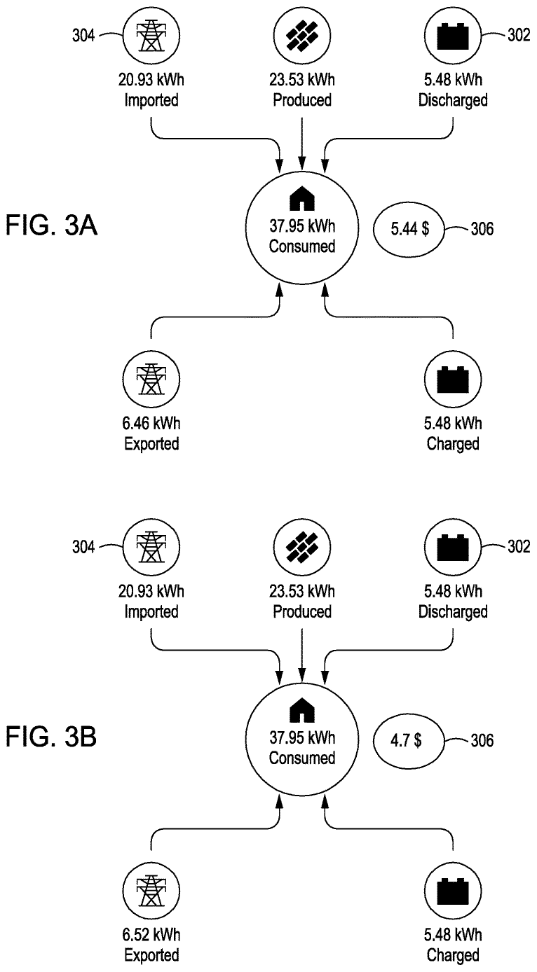

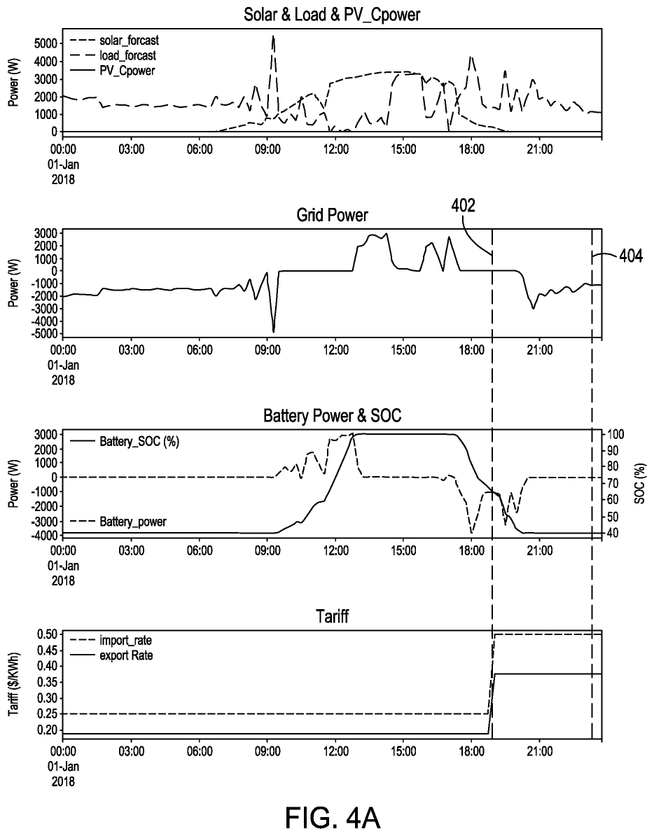

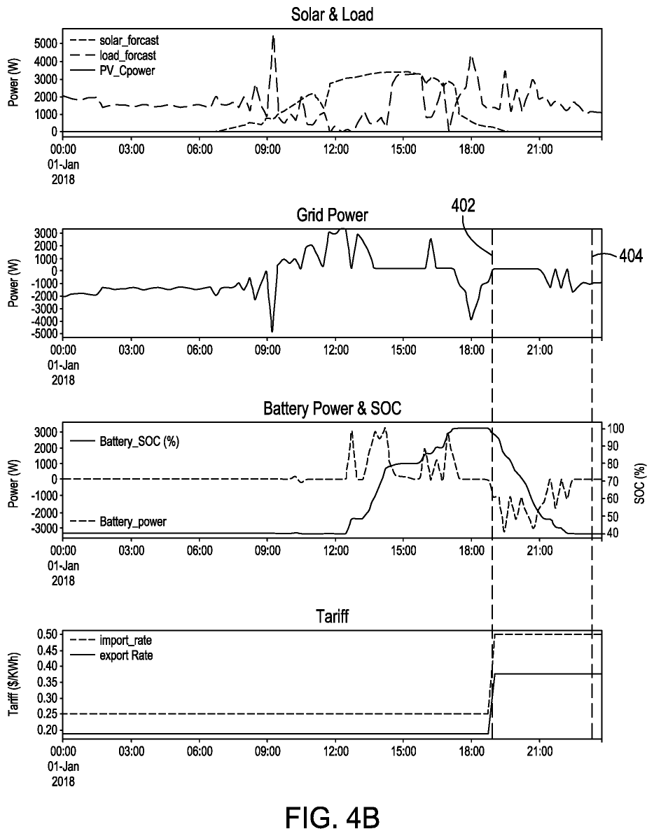

The results obtained for a 24 hr. timespan for the rule based TCE self-consumption and optimization based self-consumption (e.g., the optimization engine) are shown in FIGS. 3A and 3B and FIGS. 4A and 4B, respectively. For example, as illustrated in the FIGS. 3A and 4A, in the rule based TCE logic, in self-consumption mode, the battery is used as a first source of energy 302 followed by grid (e.g., a second source of energy 304). Therefore, the battery discharges at a maximum allowed discharge rate to meet a load requirement, until the battery reaches a reserve SoC limit. Once the battery SoC reaches the reserve SOC limit, power is imported from grid to meet the load requirements, which can happen during peak tariff periods. That is, the rule based TCE logic does not take into consideration power tariff in planning for battery schedule. Conversely, as illustrated in the FIGS. 3B and 4B, in optimization based TCE, in planning the battery schedule, grid import is minimized and at the same time some money saving is achieved. That is, the battery schedule takes into consideration when grid tariff is high. When compared to rule based TCE, the optimization-based self-consumption saves 13% more money at the same grid import energy (20.93 kWh), compare 306 with 308 and area between 402 and 404. For example, as illustrated in FIG. 4A, with the rule based TCE logic, the grid is providing power to the load during high tariff periods. Conversely, during the same time frame, with optimization based TCE logic, the battery is providing power to the load.

In at least some embodiments, the optimization engine described herein can be used for a selection of optimal trade-off between self-consumption and savings objective. For example, using the optimization-based objective mentioned with respect to Equation 1(c), a user can input a fraction (%) of cost savings and self-consumption to the optimization engine through, for example, a UI interface (or other suitable device for receiving a user input) to check trade-off between energy cost savings and import reduction for a selected time horizon from a current time. In at least some embodiments, the optimization setting and the dynamic inputs for the optimization engine that can be used are listed in Table 4 and Table 5, respectively.

TABLE 4

| Settings | Value | |
|---|---|---|
| Battery capacity | 3*3 | kWh |
| Battery Charge/Discharge rate | 3*1.28 | kW |
| Grid Import limit | 6 | kW |
| Grid export limit | 3 | kW |

| | |
|---|---|
| Charge from grid | FALSE |
| Discharge to grid | FALSE |

TABLE 5

| Dynamic inputs | Value |
|---|---|
| Solar/load forecast | in kW (24 hrs - one full day) |
| Grid import/export rates | in ($/kWh) (24 hrs - one full day) |
| Battery initial charge | 30% of Capacity |
| Battery backup charge | 30% of capacity |

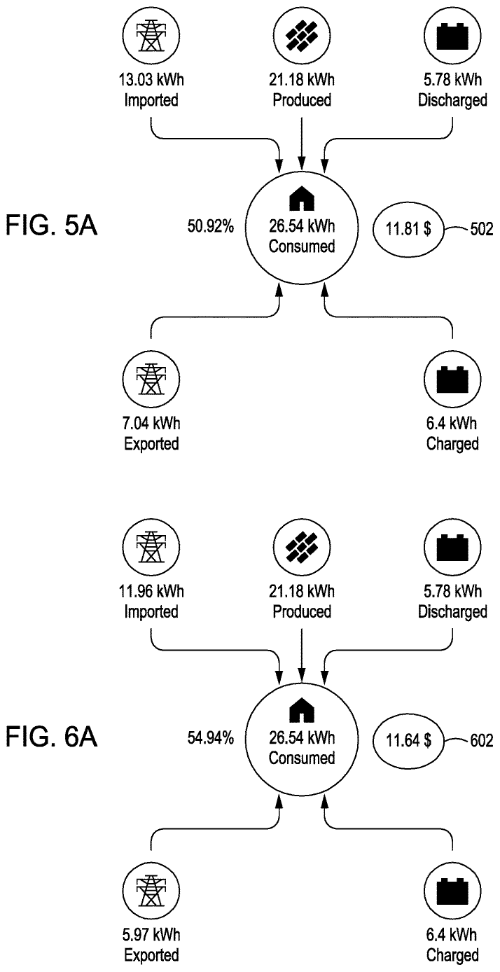

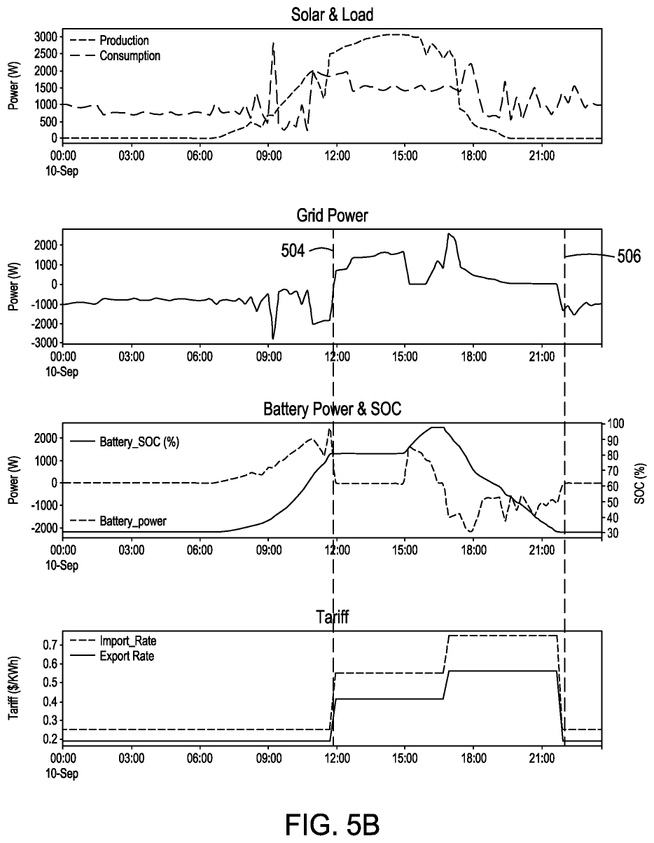

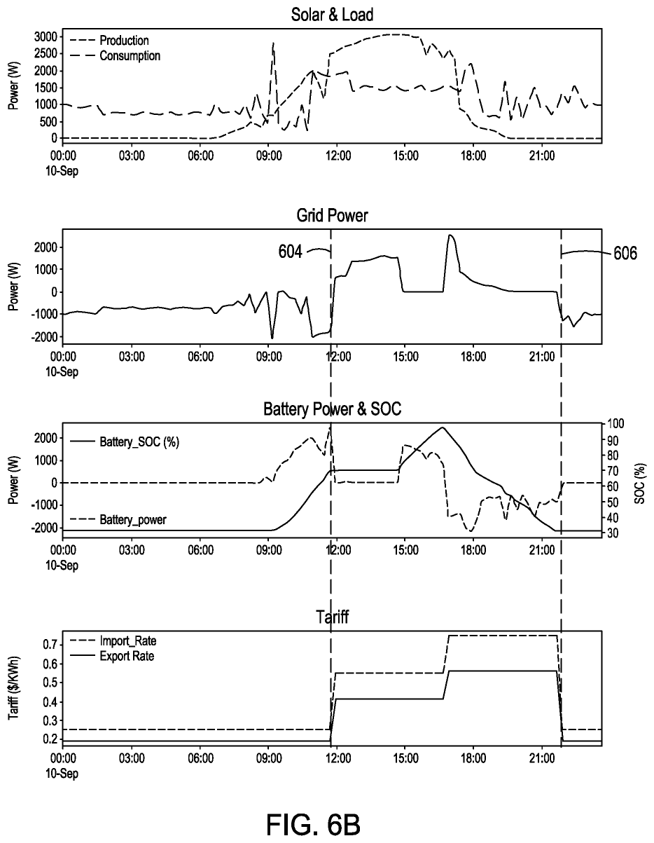

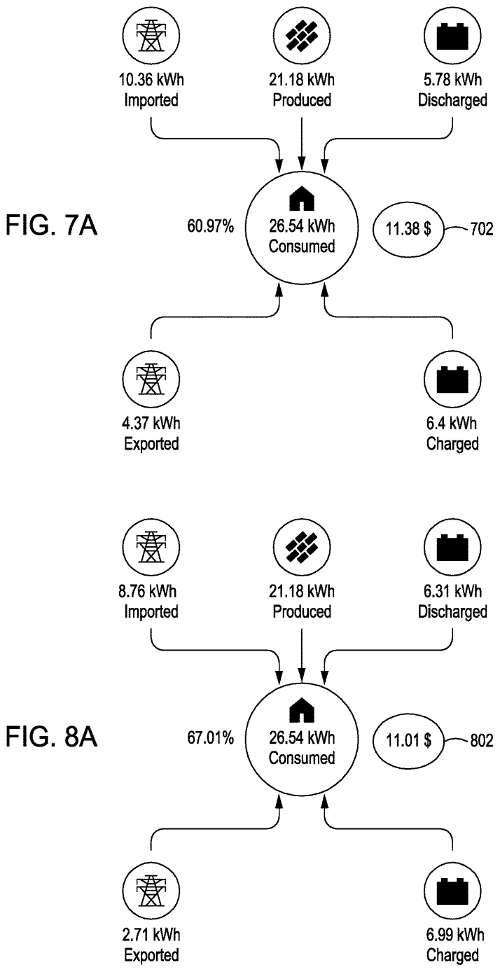

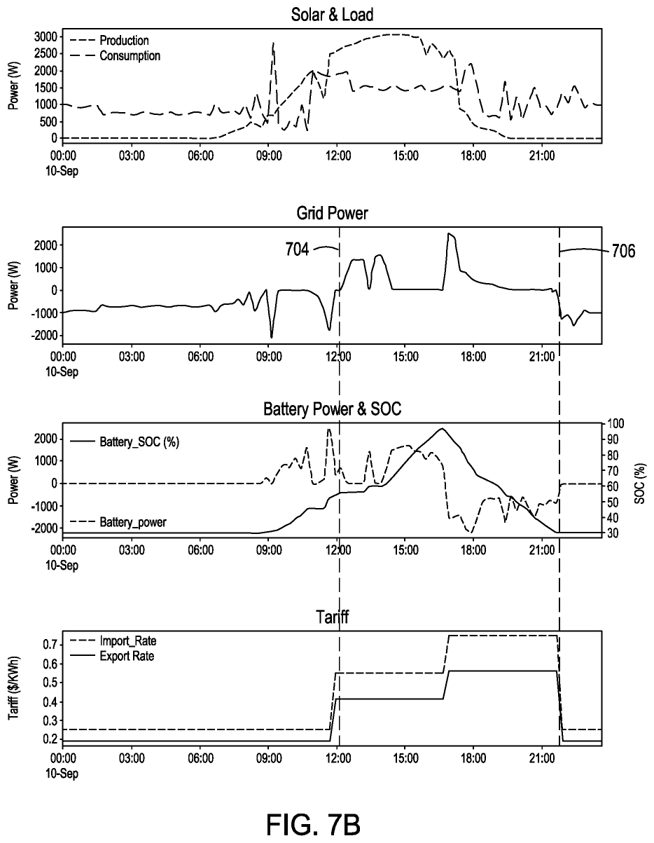

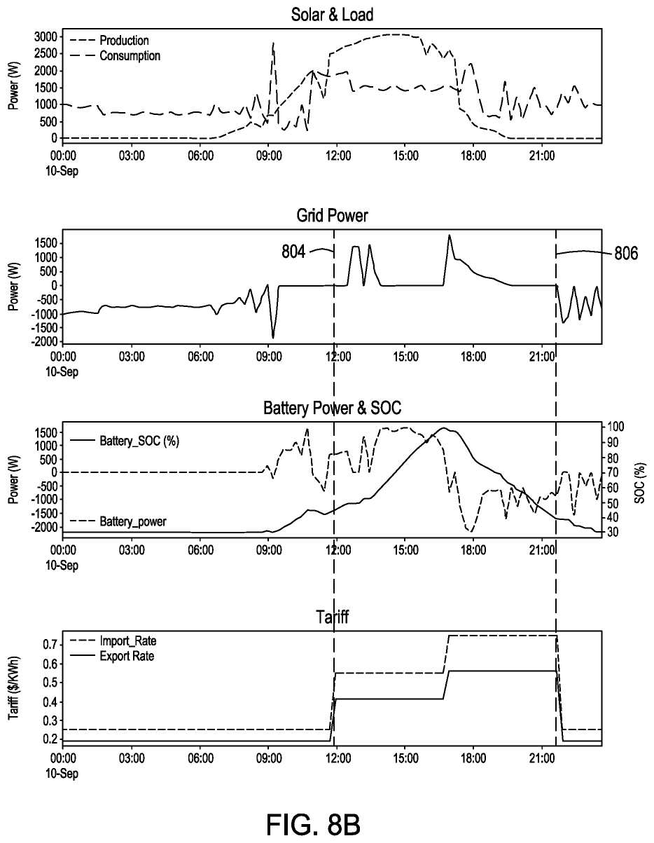

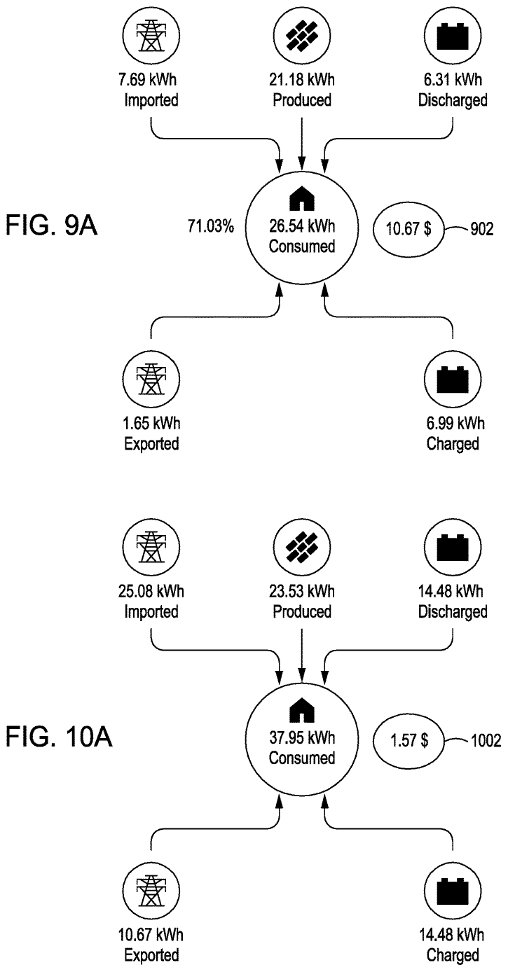

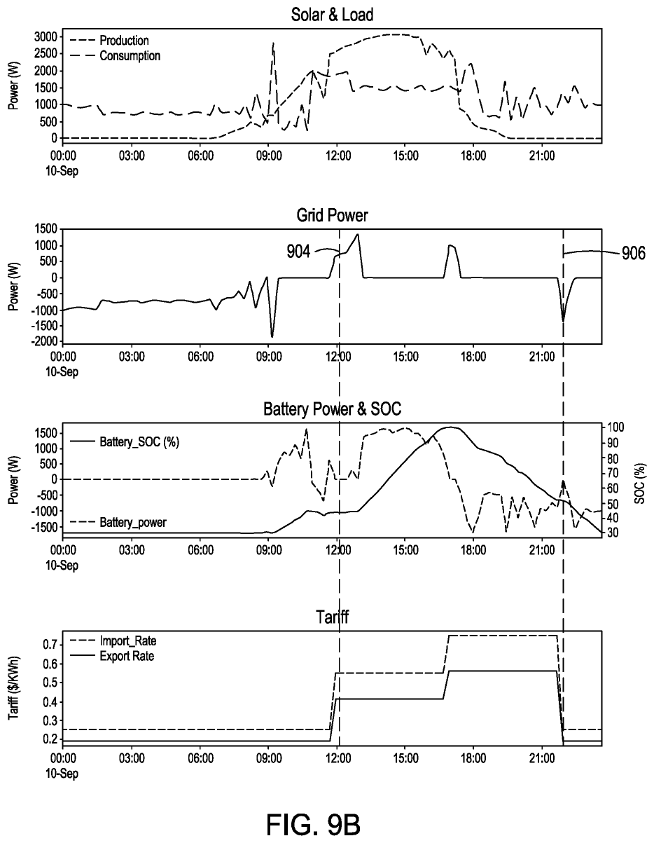

For example, as a user compromises on a savings goal, self-consumption (e.g., energy independence) grows, thus allowing a user to select proper battery operation, and vice versa, a user can choose to lose a fraction of self-consumption to improve savings. For example, in at least some embodiments, a user can select that weightage to self-consumption is 0% (see 502 and area between 504 and 506, FIGS. 5A and 5B), 20% (see 602 and area between 604 and 606, FIGS. 6A and 6B), 50% (see 702 and area between 704 and 706, FIGS. 7A and 7B), 80% (see 802 and area between 804 and 806, FIGS. 8A and 8B), and 100% (see 902 and area between 904 and 906, FIGS. 9A and 9B). A summary of the results for a selection of optimal trade-off between self-consumption and savings objective is listed in Table 6.

TABLE 6

| | Weightage | | | Enegry | |
|---|---|---|---|---|---|
| | to self- | GridImport | Energy | Indepen- | Overall |
| | consumption | Energy | Bill | dence | savings |
| FIGS. 5A/5B | 0% | 13.03 kWh | 0.033 $ | 50.92% | 11.81 $ |
| FIGS. 6A/6B | 20% | 11.96 kWh | 0.206 $ | 54.94% | 11.64 $ |
| FIGS. 7A/7B | 50% | 10.36 kWh | 0.467 $ | 60.97% | 11.38 $ |
| FIGS. 8A/8B | 80% | 8.76 kWh | 0.835 $ | 67.00% | 11.00 $ |
| FIGS. 9A/9B | 100% | 7.69 kWh | 1.169 $ | 71.03% | 10.67 $ |

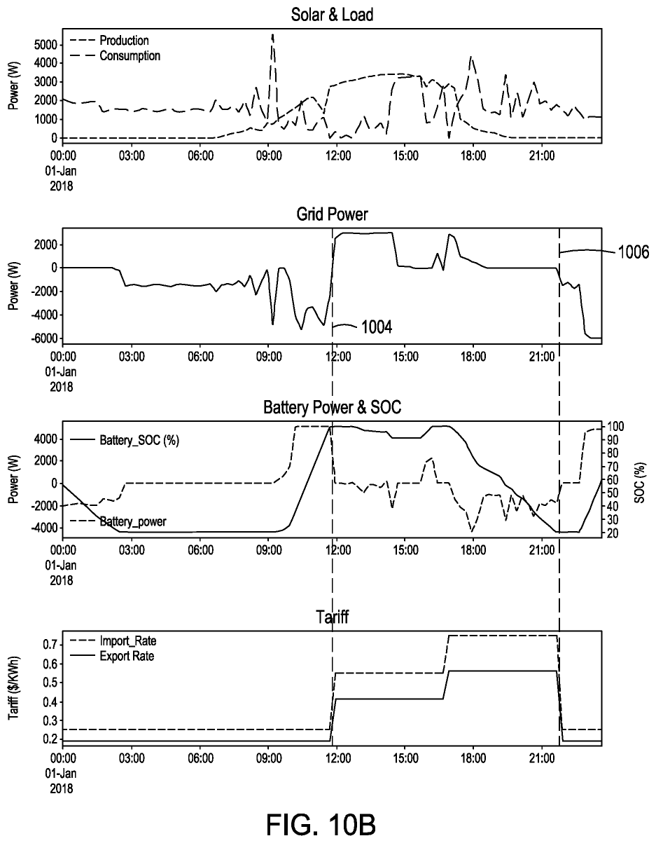

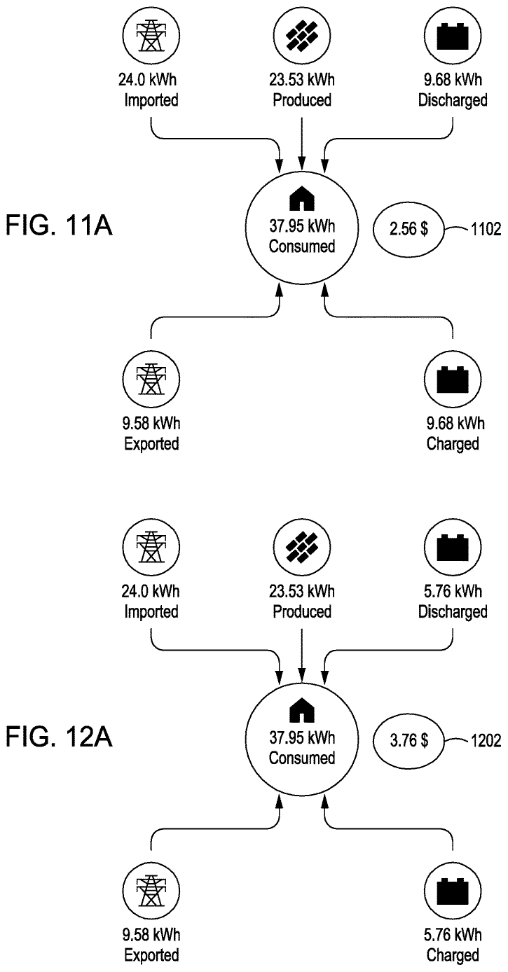

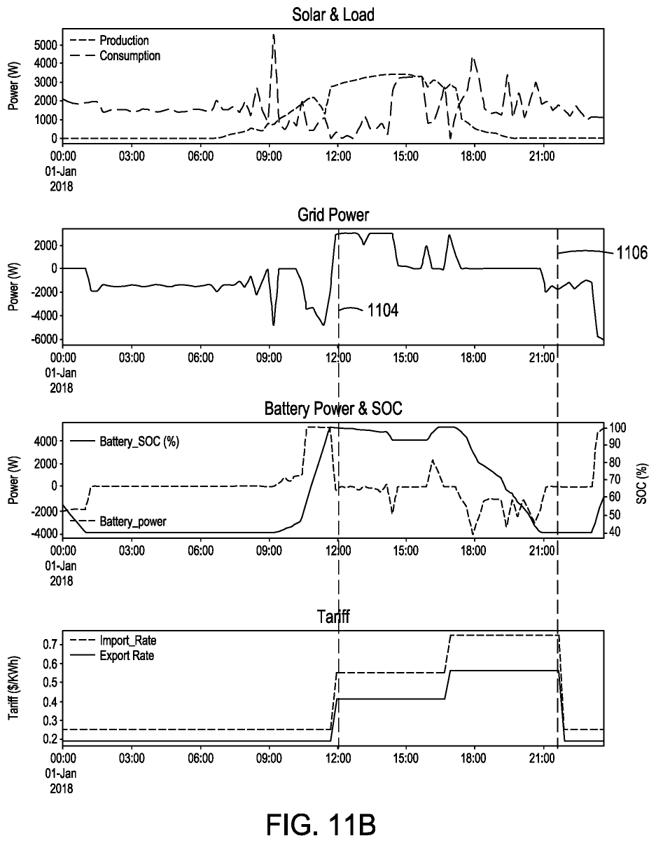

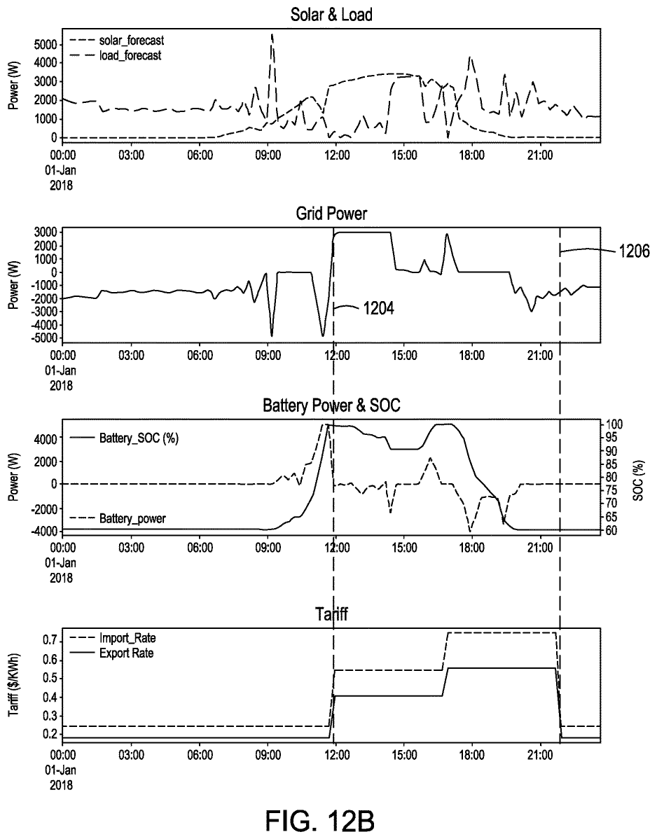

In at least some embodiments, the optimization engine described herein can be used for selection of optimal reserve state of the charge (SOC) considering the power outage possibility and opportunity to save money. For example, using the optimization-based savings objective mentioned with respect to Equation 1 (a), a user can input a reserve SoC to the optimization engine. Thus, when grid-outages occur, a user can also check a trade-off for reserve SOC with respect to cost savings for a selected time horizon and to select a correct/appropriate setting for reserve SOC. For example, when the reserve SoC was increased from 20% to 40% (see 1002 and area between 1004 and 1006, FIGS. 10A and 10B, and see 1102 and area between 1104 and 1106, FIGS. 11A and 11B), the energy cost increased by 65%. Similarly, when the reserve SoC was increased from 20% to 60% (see 1002 and area between 1004 and 1006, FIGS. 10A and 10B, and see 1202 and area between 1204 and 1206, FIGS. 12A and 12B), the energy cost increased by 120%. A summary of the results for a selection of optimal trade-off between self-consumption and savings objective is listed in Table 7.

TABLE 7

| Quantity | 10A/10B | 11A/11B | 12A/12B |
|---|---|---|---|
| Reserve SOC (% capacity) | 20% | 40% | 60% |
| Enegry cost ($) | 1.57 $ | 2.56 $ | 3.76 $ |

Additionally, in uncertain scenarios, e.g., like grid-outage due to storms, a user can perform “what if” analysis and identify a correct/appropriate setting for reserve SoC, which in at least some embodiments, can involve trade-off analysis between grid outage (e.g., low SOC situation) vs cost saving.

Moreover, in at least some embodiments, the intelligent optimization engine allows user also to select charging periods for an EV (Electric Vehicle), the amount of charge to added, only green charging and a trade-off analysis with cost savings, to select the smart grid-ready modes of HP (Heat pump) in cost savings mode. One or more user choices can also be used with optimization without compromising on cost savings/self-consumption and green energy objectives.

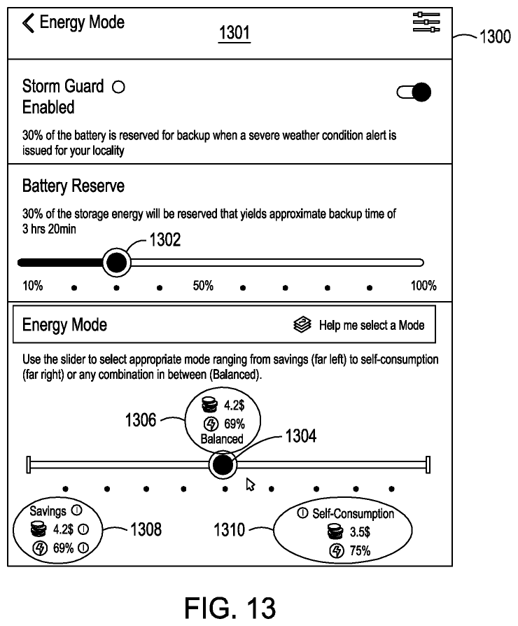

FIG. 13 is a diagram of a screenshot 1300 (e.g., an interactive UI based tool 1301), in accordance with at least one embodiment of the present disclosure. For example, the screenshot 1300 can be displayed when used for the selection of optimal trade-off between self-consumption and savings objective (e.g., FIGS. 5A-9B). The screenshot 1300 can be displayed on one or more computing devices comprising, but not limited to, a computer, laptop, smart device, etc. In at least some embodiments, the screenshot 1300 can be displayed on the mobile device 142. Unlike conventional user interface (UI), which can be configured for mode selection and only provide a user with savings and self-consumption options, the UI (e.g., the slider 1302 and the slider 1304)) associated with the screenshot 1300 (e.g., the intelligent optimization engine) allows a user to choose any combination between savings and self-consumption. For example, the slider 1304 can be configured to allow a user with the capability to select an appropriate mode ranging from savings (e.g., far left) to self-consumption (e.g., far right), or any combination in between, e.g., balanced between a saving of $4.2 and a self-consumption of 69%. Similarly, the slider 1302 can be configured to provide a user with the capability of choosing a percent of a stored energy that will be reserved and that will yield an approximate backup time, e.g., a user can select 30% of a stored energy that will be reserved and that will provide a backup time of about 3 hours and 20 minutes. Projected savings and energy independence values can be shown to the user to guide mode selection, e.g., 1306, 1308, and 1310, and similar other use-cases can be also added to the intelligent optimization engine. Additionally, the UI can allow a user to input to the intelligent optimization engine at every optimization time step and the intelligent optimization engine can be adjusted based on that input. For example, a user can select different objectives savings/self-consumption and battery reserve SOC so that a user can save more cost or prepare a reserve SOC.

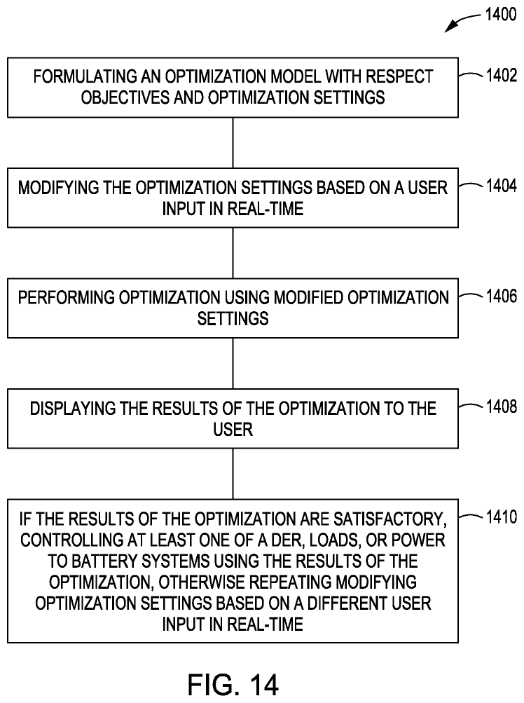

FIG. 14 is a flowchart of a method 1400 for managing an energy management system, in accordance with at least one embodiment of the present disclosure. The method 1400 provides an iterative approach to fine tune a user's choices to achieve an end objective in an intuitive manner. The optimization engine (e.g., application 146) can be stored at the DER controller 116 (e.g., a gateway) and/or at the cloud-based computing platform 128 and accessed by a user using the UI based tool 1301. For example, the interactive UI based tool 1301 (which can be displayed on a display of an electronic device, e.g., the mobile device 142) allows a user to input settings to the optimization engine, which under the control of a controller (e.g., the DER controller 116), can adjust/control one or more components of the energy management system in real-time, e.g., the DER 118, loads, power to/from battery systems or storage systems, etc.

For example, at 1402, the method 1400 can comprise formulating an optimization model with respect to various objectives and optimization settings. For example, as described above, the objectives can comprise savings and/or self-consumption. In at least some embodiments, the optimization engine can use one or more of the Equations 1(a) to 4(a) and/or one or more of the parameters listed in the Tables 1 to 5.

Next, at 1404, the method 1400 can comprise modifying optimization settings (e.g., information from tables 2 to 5) based on a user input provided in real-time or near real-time (e.g., based on a user selection on the screenshot 1300). For example, the user can use the slider 1302 and/or the slider 1304) to adjust a battery reserve and/or an energy mode, respectively.

Next, at 1406, the method 1400 can comprise performing optimization using modified optimization settings. For example, the optimization engine can be run using the user input at 1404.

Next, at 1408, the method 1400 can comprise displaying the results of the optimization to the user (e.g., 1306, 1308, or 1310).

Next, at 1410, the method 1400 can comprise if the results of the optimization are satisfactory, controlling the DER 118, loads, power to/from battery systems or storage systems, etc. using the results (e.g., values) of the optimization; otherwise repeating modifying optimization settings based on a different user input in real-time.

While the foregoing is directed to embodiments of the present disclosure, other and further embodiments of the disclosure may be devised without departing from the basic scope thereof, and the scope thereof is determined by the claims that follow.

1. A method for managing an energy management system, comprising:
formulating an optimization model with respect to objectives and optimization settings;
modifying the optimization settings based on a user input provided on an electronic device;
performing optimization using modified optimization settings;
displaying results of the optimization to a user on the electronic device; and
if the results of the optimization are satisfactory, controlling at least one of a DER, loads, or power to battery systems using the results of the optimization, otherwise repeating modifying optimization settings based on a different user input provided on the electronic device.

2. The method of claim 1, wherein the objectives can comprise at least one of savings objective or self-consumption objective.

3. The method of 2, wherein the savings objective is based on at least one of import charges, export charges, demand charge rates, or threshold-based power tariffs.

4. The method of 2, wherein the self-consumption objective is based on minimizing imported energy from a grid and maximizing in-house generated energy.

5. The method of claim 1, wherein the objectives can comprise savings objective or self-consumption objective.

6. The method of claim 1, wherein the user input is provided in real-time or near real-time on the electronic device.

7. The method of claim 6, wherein the user input is provided on a display of the electronic device.

8. The method of claim 1, wherein the user input is provided using a slide that adjusts at least one of a battery reserve or an energy mode.

9. A non-transitory computer readable storage medium having instructions stored thereon that when executed by a processor perform a method for managing an energy management system, comprising:
formulating an optimization model with respect to objectives and optimization settings;
modifying the optimization settings based on a user input provided on an electronic device;
performing optimization using modified optimization settings;
displaying results of the optimization to a user on the electronic device; and
if the results of the optimization are satisfactory, controlling at least one of a DER, loads, or power to battery systems using the results of the optimization, otherwise repeating modifying optimization settings based on a different user input provided on the electronic device.

10. The non-transitory computer readable storage medium of claim 9, wherein the objectives can comprise at least one of savings objective or self-consumption objective.

11. The non-transitory computer readable storage medium of claim 10, wherein the savings objective is based on at least one of import charges, export charges, demand charge rates, or threshold-based power tariffs.

12. The non-transitory computer readable storage medium of claim 10, wherein the self-consumption objective is based on minimizing imported energy from a grid and maximizing in-house generated energy.

13. The non-transitory computer readable storage medium of claim 9, wherein the objectives can comprise savings objective or self-consumption objective.

14. The non-transitory computer readable storage medium of claim 9, wherein the user input is provided in real-time or near real-time on the electronic device.

15. The non-transitory computer readable storage medium of claim 14, wherein the user input is provided on a display of the electronic device.

16. The non-transitory computer readable storage medium of claim 9, wherein the user input is provided using a slide that adjusts at least one of a battery reserve or an energy mode.

17. A controller configured for use with an energy management system, comprising:
a tertiary control engine configured to:
formulate an optimization model with respect to objectives and optimization settings;
modify the optimization settings based on a user input in real-time;
perform optimization using modified optimization settings;
display results of the optimization to a user; and
if results of the optimization are satisfactory, control at least one of a DER, loads, or power to battery systems using the results of the optimization, otherwise repeating to modify optimization settings based on a different user input in real-time.

18. The controller of claim 17, wherein the objectives can comprise at least one of savings objective or self-consumption objective.

19. The controller of claim 18, wherein the savings objective is based on at least one of import charges, export charges, demand charge rates, or threshold-based power tariffs.

20. The controller of claim 18, wherein the self-consumption objective is based on minimizing imported energy from a grid and maximizing in-house generated energy.
